(19) United States
(12) Patent Application Publication
(10) Pub. No.: US 2002/0110179 A1
(43) Pub. Date: Aug. 15, 2002

(54) Method and apparatus for identifying thermometers

(76) Inventor: Ronald G. LeTourneau, Canton, MI (US)

Correspondence Address: WILLIAM G. CONGER, Brooks & Kushman P.C., 22nd Floor, 1000 Town Center, Southfield, MI, 48075-1351, US

(21) Appl. No.: 09/880,319

(22) Filed: Jun. 13, 2001

Related U.S. Application Data
(60) Provisional application No. 60/267,666, filed on Feb. 9, 2001.

(51) Int. Cl. G01K 1/00; G09F 3/08; G09F 3/00

(52) U.S. Cl. 374/141; 116/200; 40/625; 40/299.01

(57) ABSTRACT

Substantially similar thermometers present in the same locality are distinguished from each other by the attachment of distinguishing indicia or by supplying non-critical portions of said thermometers in a plurality of colors and/or designs.

### CROSS-REFERENCE TO RELATED APPLICATION

This application claims the benefit of U.S. provisional application Serial No. 60/267,666, filed Feb. 9, 2001.

### BACKGROUND OF THE INVENTION

1. Field of the Invention

The invention relates to a method and apparatus for identifying different clinical thermometers in a single location. More specifically, the invention relates to a method and apparatus for identifying and distinguishing between several thermometers in a single location.

2. Background Art

It is often desirable to be able to distinguish among a plurality of clinical thermometers in a given location. For example, many families use thermometers to monitor or diagnose a variety of medical conditions, particularly infections. Such infections may often be easily transmitted from one person to another. One source of “transfection” is the use of thermometers by several people without adequate sterilization inbetween. Especially in the home consumer environment, it is difficult to attain the requisite degree of sterilization. In families with several children, a real risk of spreading infection thus exists.

In the past, it has been virtually impossible to distinguish one thermometer from another unless different types or brands of thermometers are purchased. It would be desirable to enable substantially similar thermometers to be readily distinguishable from each other without requiring modification of components such that manufacturing costs are unduly increased.

### SUMMARY OF THE INVENTION

Thus, the invention pertains to a method for distinguishing first and second substantially similar thermometers from each other in a location where a plurality of said substantially similar thermometers are located. The method includes one or more of: a) supplying said thermometers with externally observable distinguishable colors; b) supplying said thermometers manufactured to contain a distinguishing indicia attachment means; and/or c) supplying a plurality of distinguishing indicia. Each of the individual indicia are adapted to be mounted onto one of said thermometers.

The invention further pertains to a kit including a plurality of substantially identical thermometers. A plurality of different distinguishing indicia, individual indicia adapted to be attached to individual thermometers, is contained in the kit.

The invention still further pertains to a kit including a plurality of distinguishable but substantially similar thermometers. The thermometers are of the same general size and shape. Each individual thermometer may differ from other thermometers in the kit by having a non-critical portion of a different color or design.

The invention further pertains to a kit comprising a plurality of different distinguishing indicia, configured such that individual distinguishing indicia may be attached to individual thermometers, such that individual thermometers of the same general appearance may be distinguished from each other.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a side view of two thermometers side-by-side;

FIG. 2 is a view of slip-on identifying indicia mounted on a thermometer of FIG. 1;

FIG. 3 illustrates a digital thermometer having an indicia receiving cavity molded into the thermometer case;

FIGS. 3A and 3B illustrate side views of a portion of a thermometer as in FIG. 3, with two different indicia receiving cavities;

FIG. 4A illustrates a thermometer or thermometer case containing a groove adapted to receive an elastomeric or resilient plastic distinguishing band;

FIG. 4B illustrates a distinguishing band on the thermometer of FIG. 4A; and

FIG. 5 illustrates a thermometer having a shallow recess molded into the case, adapted to receive a distinguishing indicia in the area of the recess.

FIG. 6 illustrates another embodiment of the subject invention thermometers.

### DETAILED DESCRIPTION OF THE PREFERRED EMBODIMENT

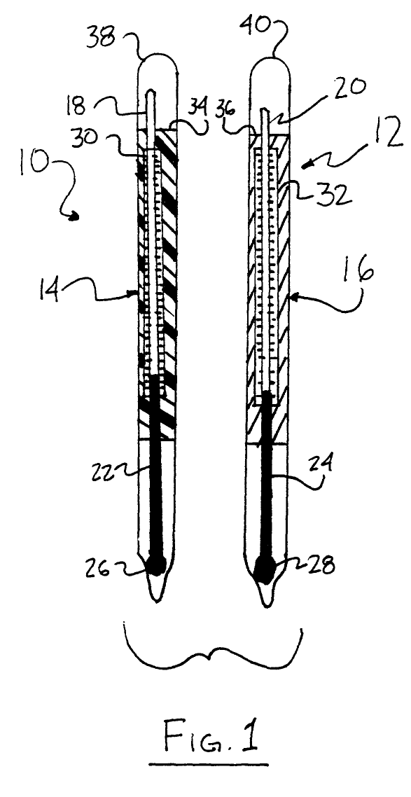

Referring to FIG. 1, two thermometers are generally shown at 10,12. The thermometers 10,12 are shown to be non-battery operated. It should be appreciated by those skilled in the art that any type and style of thermometer may incorporate the invention without adding thereto.

The thermometers 10,12 have a readable portion 14,16. The readable portion 14,16 includes a transparent cylinder 18,20 with thermometric fluid 22,24 stored in a reservoir end 26,28 thereof. As the temperature rises when the thermometer 10,12 is disposed adjacent the person for whom a measurement is desired, the fluid 22,24 expands and fills the cylinder 18,20 as is well known in the art.

A scale 30,32 extends along the readable portion 14,16 allowing the observer of the thermometer 10,12 to correlate the expansion of the fluid 22,24 with the temperature of the person for whom a measurement had been taken.

A marked region 34,36 extends along the thermometer 10,12 outside the scale 30,32 thereof. The marked region 34,36 identifies the thermometer 10,12 as a particular thermometer 10 as opposed to another thermometer 12. More specifically, in the prior art, there is no indication of one thermometer over another absent a difference in brands. As the tooling and production costs for manufacturing thermometers with noticeably different configurations is expensive, it is generally prohibitive to manufacture more than one configuration unless the changed element constitutes only a small and relatively non-critical portion of the design. The invention utilizes the marked region 34,36 to differentiate between individual thermometers 10,12 even though they are of the same brand and/or model.

In the preferred embodiment, the marked region 34 in one thermometer 10 differs from the marked region 36 in the other thermometer 12 through the use of color. In FIG. 1, the colors used in each of the marked regions 34,36 are distinguished by the use of different crosshatch patterns. One marked region 34 is one color and the other marked region 36 is another color. This allows, for example, members of the same residence to identify specific thermometers 10,12 so that individuals of that residence can limit their use of thermometers to a specific thermometer 10,12. This further hinders the transmission of diseases from one person (or animal) to another.

In alternative embodiments not shown herein, the marked regions could utilize patterns of colors, names, numbers and the like. The distinguishing features of the marked regions are not limited to the list set forth above and may include any type of distinguishing marks that serve such a purpose.

Further, the marked region is not limited to the region around the scale 30,32. The marked region may include the highly visible tip portion 38,40 found opposite the reservoir end 26,28 or any other portion of the thermometer 10,12 that does not restrict or hinder the view of the fluid 22,24 as it expands through the cylinder 18,20.

In the situation wherein a digital thermometer (not shown) is used, any portion of the digital thermometer can be used as the marked portion other than the digital readout.

Thus, for example, the thermometer of FIG. 1 may be designed to receive a slip-on cap, i.e. one made of a resilient metal, plastic, or elastomeric material, these caps not being critical to the positioning or encasing of the thermometric elements of the thermometer. Such a cap is shown in FIG. 2, where the cap 42 is positioned over the topmost portion 40 of the thermometer 16. The caps 42 may be of different colors or may bear numbers or names. The cap 42 may optionally be surmounted by a distinguishing portion 44, here, a “smiley face.” Cartoon characters, “teddy bear” shapes, etc. may be used as well.

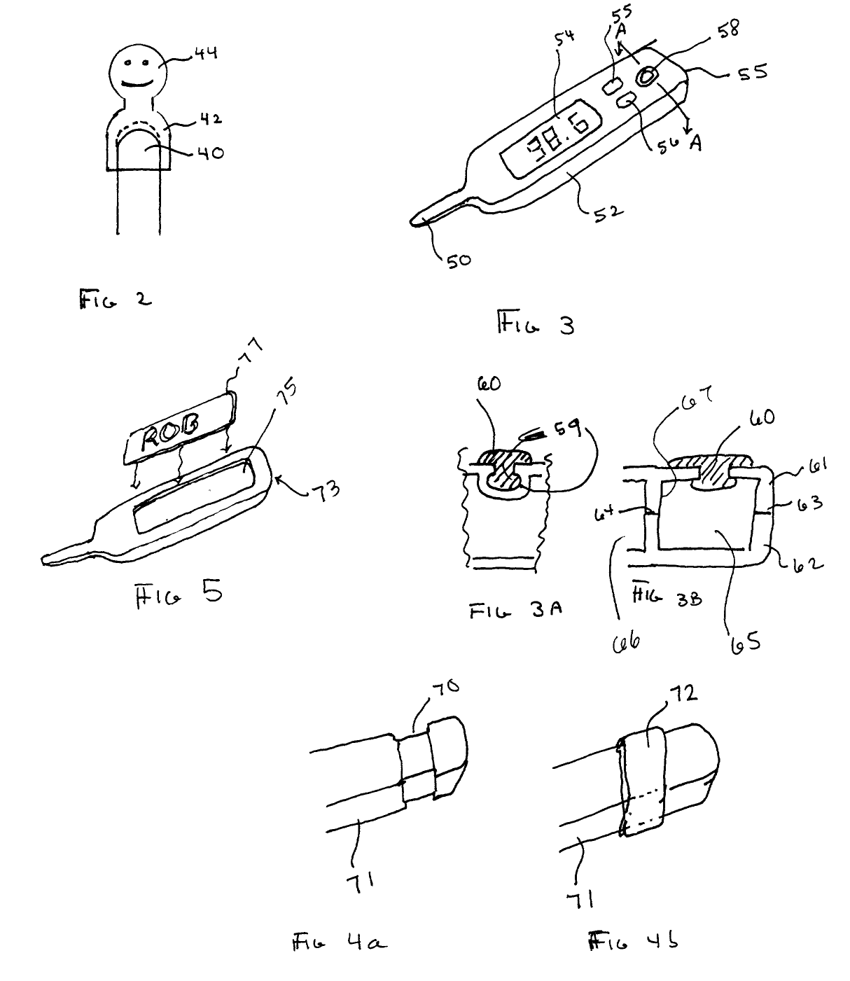

In FIG. 3 is illustrated a digital thermometer, including a sensing element 50, a case 52, the case being generally constructed of polymeric material, and a digital display 54. The thermometer generally also contains various control buttons 55,56, e.g. for turning the thermometer on and off, resetting the display, etc. At 58 is a well, cavity, or hole shown in cross-section in FIG. 3A, preferably having a sightly undercut wall 59 adapted to receive a “button” 60 of elastomeric material or resilient plastic. The button may be supplied in different colors or geometric shapes, designs, etc., and because of its small size, may be readily manufactured at low cost. The buttons may be “snapped” into place by the user, and replaced or changed when desired. In FIG. 3B is shown a similar housing where the two halves of the thermometer case 61 and 62 are joined at 63,64 and forms a cavity 65, the front wall 67 of which isolates the working components in the forward portion 66 of the case from the hole-containing portion.

The case or a portion thereof, i.e., one case half, may be manufactured from different colored polymeric material, as switching from one color plastic to another is a non-critical change which can easily and expensively be made without changing dies, etc. By a non-critical portion or change is meant a part of the thermometer whose color, shape, etc., can be changed without manufacturing new dies or altering manufacturing techniques such that cost is increased. A change which alters the general shape of a major portion of a thermometer case, whether of the thermometric fluid type of digital type, is not a “non-critical” change. Manufacture of a small portion of a case in a plurality of shapes, for example a cap portion, is a non-critical change and a non-critical part. Altering the color of a portion of a thermometer will not be a non-critical change.

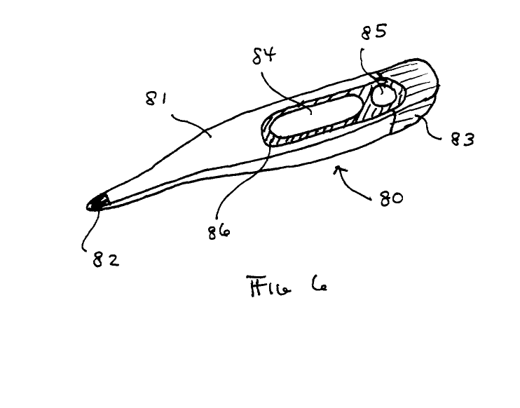

The thermometers may also be configured to receive a band as shown in FIGS. 4A and 4B, where in FIG. 4A, a recessed channel or groove 70 is molded into the thermometer case 71, and an elastomeric or resilient polymer band 72, i.e. of different colors and/or bearing distinguishing logos is slipped over the case and retained in the groove.

A distinguishing indicia is a separately manufactured part, generally of elastomeric polymer or resilient plastic, which can be attached to the thermometer case in such a manner that the indicia is unlikely to be removed except purposefully.

FIG. 5 illustrates a digital thermometer 73 whose back side contains a recess 75 molded into the case, this recess adapted to receive an identifying indicia 77, in this case, bearing a name. Indicia of various colors may be used as well. The indicia 77 preferably has a pressure-sensitive adhesive on its back surface to facilitate attachment to the case. The case need not have a recess, and for example, may have a smooth surface to receive the adhesive indicia. A display containing a collection of such adhesive indicias bearing common names and nicknames can advantageously be located proximate to the display location of the thermometers at a retail sales establishment.

FIG. 6 illustrates a digital thermometer 80 having an injection molded, one-piece lower case 81, a temperature sensing element 82, a top injection-molded “cap” portion 83, an LCD display 84, and a start button 85. The display 84 and start button 85 are surrounded by a molded insert 86. The thermometer 80 may be rendered distinguishable from other substantially similar thermometers by varying the color of the insert 86, the start button 85, and/or the cap 83. As each of the aforementioned components is already an essential part of the particular thermometer 80, and as changing the color of these respective components may be accomplished easily and inexpensively merely by changing the color of the respective thermoplastic molding composition, each of the aforementioned methods of creating substantially similar but readily distinguishable thermometers is a non-critical change in manufacturing.

In general, it is desirable, when thermometers are of the same color, and distinguishing indicia are used, to manufacture the thermometer case to contain a recess, groove, or protuberance specifically for the purpose of receiving the distinguishing indicia. The invention does not pertain to the attachment of adhesive tape, masonry tape, etc., to a thermometer, but rather pertains to use of manufactured indicia.

While the best mode for carrying out the invention has been described in detail, those familiar with the art to which this invention relates will recognize various alternative designs and embodiments for practicing the invention as defined by the following claims.

What is claimed is:

1. A method for distinguishing first and second substantially similar thermometers from each other in a location where a plurality of said substantially similar thermometers are located, said method comprising one or more of:
a) supplying said thermometers with externally observable distinguishable colors;
b) supplying said thermometers manufactured to contain a distinguishing indicia attachment means and attached different distinguishing indicias to said first and second thermometers; and
c) supplying a plurality of distinguishing indicia, each individual indicia adapted to be mounted onto one of said thermometers, and mounting different distinguishing indicia on said first and second thermometers.

2. The method of claim 1, wherein each of said thermometers contain a thermometric fluid within a tube and a scale adjacent said tube, each of said scales being manufactured in a different one of a plurality of colors and/or designs such that two or more of said plurality of thermometers may be distinguished from each other due to the differences in said color and/or design of said scale.

3. The method of claim 1, wherein each of said thermometers is a digital thermometer having a case.

4. The method of claim 3, wherein each of said cases comprises one or more portions molded of a polymer material, said method further comprising supplying a plurality of thermometers having at least one case portion having a different appearance relative to at least another one of two of said thermometer case portions.

5. The method of claim 4, wherein said case is molded to contain at least one distinguishing indicia attachment means.

6. The method of claim 5, wherein said attachment means is selected from a groove or depression encircling said case and adapted to receive a distinguishing band; a hole in said case adapted to receive a button; and a protuberance adapted to receive a cap.

7. The method of claim 1, comprising:
supplying a plurality of substantially identical thermometers and a plurality of different, distinguishing indicia, and individual indicia adapted to be attached to a thermometer.

8. A kit, comprising:
a) a plurality of substantially identical thermometers; and
b) a plurality of different distinguishing indicia, individual indicia adapted to be attached to individual thermometers contained in said kit.

9. A kit, comprising:
a plurality of distinguishable thermometers, said thermometers being of the same general size and shape, individual thermometers differing from other thermometers in said kit by having a non-critical portion of a different color or design.

10. The kit of claim 9, wherein said thermometers are thermometers having a tube of thermometric liquid and a separate scale in proximity thereto, the scale of individual thermometers differing from at least one other thermometer in said kit by being of different color or design.

11. The kit of claim 9, wherein said thermometers are digital thermometers of identical size and shape but having cases or a portion thereof, at least two thermometers molded from polymer material of different color and/or design than each other.

12. A kit comprising a plurality of different distinguishing indicia shaped such that individual distinguishing indicia may be attached to an individual thermometer, such that individual thermometers of the same general appearance may be distinguished from each other.

13. The method of claim 1, comprising supplying a plurality of different distinguishing indicia in the form of a planar geometric shape bearing a pressure-sensitive adhesive on one side to attach the distinguishing indicia to said thermometer.

14. The method of claim 13, wherein the case of the thermometer is molded to contain a shallow recess of the same geometric shape as the pressure-sensitive adhesive-coated distinguishing indicia.
